(19) United States
(12) Patent Application Publication
(10) Pub. No.: US 2015/0353816 A1
(43) Pub. Date: Dec. 10, 2015

(54) FRACTURING SYSTEMS AND METHODS INCORPORATING HUMAN INGESTIBLE PRODUCTS

(71) Applicant: ProStim Labs, LLC, Houston, TX (US)

(72) Inventors: John F. Thrash, Houston, TX (US); Robert S. Lestz, Missouri, TX (US)

(21) Appl. No.: 14/825,089

(22) Filed: Aug. 12, 2015

Related U.S. Application Data
(63) Continuation-in-part of application No. 14/735,745, filed on Jun. 10, 2015.
Application No. 14/735,745 is a continuation-in-part of application No. 14/511,858, filed on Oct. 10, 2014.
Application No. 14/511,858 is a continuation-in-part of application No. 14/199,461, filed on Mar. 6, 2014.
(60) Provisional application No. 62/010,302, filed on Jun. 10, 2014.
(60) Provisional application No. 61/889,187, filed on Oct. 10, 2013.
(60) Provisional application No. 62/036,297, filed on Aug. 12, 2014.
(60) Provisional application No. 62/036,284, filed on Aug. 12, 2014.
(60) Provisional application No. 61/915,093, filed on Dec. 12, 2013.
(60) Provisional application No. 61/870,350, filed on Aug. 27, 2013.
(60) Provisional application No. 61/807,699, filed on Apr. 2, 2013.
(60) Provisional application No. 61/790,942, filed on Mar. 15, 2013.
(60) Provisional application No. 61/774,237, filed on Mar. 7, 2013.

(51) Int. Cl. C09K 8/80; E21B 43/267; E21B 43/26

(52) U.S. Cl. CPC C09K 8/80; E21B 43/26; E21B 43/267

(57) ABSTRACT

The disclosure contained herein provides fracturing systems and methods including human ingestible materials.

### CROSS-REFERENCE TO RELATED APPLICATIONS

This application claims priority to U.S. Nonprovisional patent application Ser. No. 14/735,745, filed Mar. 10, 2015, which claims priority to U.S. Nonprovisional patent application Ser. No. 14/511,858, filed Oct. 10, 2014, U.S. Provisional Patent Application No. 62/036,284, filed Aug. 12, 2014, U.S. Provisional Patent Application No. 62/036,297, filed Aug. 12, 2014, U.S. Provisional Patent Application No. 62/010,302, filed Jun. 10, 2014, and U.S. Nonprovisional patent application Ser. No. 14/199,461, filed Mar. 6, 2014, all of which are hereby incorporated by reference in their entireties.

This application claims priority to U.S. Nonprovisional patent application Ser. No. 14/511,858, filed Oct. 10, 2014, which claims priority to U.S. Nonprovisional patent application Ser. No. 14/199,461, filed Mar. 6, 2014, U.S. Provisional Patent Application No. 61/915,093, filed Dec. 12, 2013, U.S. Provisional Patent Application No. 61/889,187, filed Oct. 10, 2013, U.S. Provisional Patent Application No. 61/870,350, filed Aug. 27, 2013, U.S. Provisional Patent Application No. 61/807,699, filed Apr. 2, 2013, U.S. Provisional Patent Application No. 61/790,942, filed Mar. 15, 2013, and U.S. Provisional Patent Application No. 61/774,237, filed Mar. 7, 2013, all of which are hereby incorporated by reference in their entireties.

This application claims priority to U.S. Nonprovisional patent application Ser. No. 14/199,461, filed Mar. 6, 2014, which claims priority to U.S. Provisional Patent Application No. 61/915,093, filed Dec. 12, 2013, U.S. Provisional Patent Application No. 61/889,187, filed Oct. 10, 2013, U.S. Provisional Patent Application No. 61/870,350, filed Aug. 27, 2013, U.S. Provisional Patent Application No. 61/807,699, filed Apr. 2, 2013, U.S. Provisional Patent Application No. 61/790,942, filed Mar. 15, 2013, and U.S. Provisional Patent Application No. 61/774,237, filed Mar. 7, 2013, all of which are hereby incorporated by reference in their entireties.

This application claims priority to U.S. Provisional Patent Application No. 62/036,284, filed Aug. 12, 2014, which is hereby incorporated by reference in its entirety.

This application claims priority to U.S. Provisional Patent Application No. 62/036,297, filed Aug. 12, 2014, which is hereby incorporated by reference in its entirety.

### FIELD OF THE INVENTION

The present disclosure relates generally, to systems, methods, devices, and compositions thereof usable within a wellbore, and more specifically, to systems and methods for fracturing a formation using materials that are ingestible by humans to stimulate production (e.g., of hydrocarbons) therefrom.

### BACKGROUND OF THE INVENTION

To stimulate and/or increase the production of hydrocarbons from a well, a process known as fracturing is performed. In brief summary, a pressurized fluid—often water—is pumped into a producing region of a formation at a pressure sufficient to create fractures in the formation, thereby enabling hydrocarbons to flow from the formation with less impedance. Solid matter, such as sand, ceramic beads, and/or similar particulate-type materials, can be mixed with the fracturing fluid, this material generally remaining within the fractures after the fractures are formed. The solid material, known as proppant, serves to prevent the fractures from closing and/or significantly reducing in size following the fracturing operation, e.g., by “propping” the fractures in an open position. Some types of proppant can also facilitate the formation of fractures when pumped into the formation under pressure. While the presence of proppant in the fractures can hinder the permeability of the formation, e.g., by impeding the flow of hydrocarbons toward the wellbore, the increased flow created by the propped fractures normally outweighs any impedance caused by the proppant. The materials being transported into a formation for the purposes of fracturing may be referred to as “fracturing material.” The fracturing material may comprise any material that is being transported into a formation for fracturing purposes, and may include fluids, gasses, solids, or combinations thereof.

Fracturing using aqueous fluids is often undesirable due to the negative effects of water on the formation. For example, clays and other formation components can swell when exposed to water, while salts and other formation components may dissolve, such that exposure to a significant quantity of water can destabilize a formation. Use of water and other aqueous fluids also generates issues regarding disposal. Specifically, aqueous fracturing fluid recovered from a well (e.g., subsequent to a fracturing operation) contains various wellbore fluids and other chemicals (e.g., additives to facilitate fracturing using the fluid), and as such, the recovered fracturing fluid must be collected and stored at the surface and disposed of in an environmentally acceptable manner, as required by numerous regulations. Such a process can add considerable time and expense to a fracturing operation.

Non-aqueous fracturing fluids have been used as an alternative, one such successful class including hydrocarbon-based fluids (e.g., crude/refined oils, methanol, diesel, condensate, liquid petroleum glass (LPG) and/or other aliphatic or aromatic compounds). Hydrocarbon-based fracturing fluids are inherently compatible with most reservoir formations, being generally non-damaging to formations while creating acceptable fracture geometry. However, due to the flammability of hydrocarbon-based fluids, enhanced safety preparations and equipment are necessary when using such fluids for wellbore operations. Additionally, many hydrocarbon-based fluids are volatile and/or otherwise unsuitable for use at wellbore temperatures and pressures, while lacking the density sufficient to carry many types of proppant. As such, it is common practice to use chemical additives (e.g., gelling agents, viscosifiers, etc.) to alter the characteristics of the fluids. An example a system describing use of liquid petroleum gas is described in U.S. Pat. No. 8,408,289, which is incorporated by reference herein in its entirety. Use of chemical additives generates waste and disposal issues similar to those encountered when performing fracturing operations using aqueous fluids.

### BRIEF SUMMARY OF THE INVENTION

Embodiments usable within the scope of the present disclosure include systems usable for stimulating a formation (e.g., by forming fractures therein), such as through the provision of pressurized fluid to the formation through a wellbore. A fluid supply system, adapted to provide a fluid (e.g., a fracturing fluid, such as propane, other alkanes, halogenated hydrocarbons, other hydrocarbons, or any other fracturing fluid, such as water) can be provided in fluid communication with the formation. A power subsystem that includes one or more pumps (e.g., high pressure pumps, usable for fracturing operations) in communication with the fluid can be used to pressurize the fluid to a pressure sufficient to stimulate the formation. In an embodiment, a proppant addition system can be used to provide solid material (e.g., proppant, such as sand, ceramic, beads, glass bubbles, crystalline materials, or any other solid and/or particulate matter usable to maintain fractures in a formation) into the fluid.

In addition to the one or more pumps, the power subsystem can include an electric-powered driver (e.g., an electric motor) communicating with and actuating the pump(s), and an electrical power source (e.g., a turbine-powered generator, a grid power source, and/or another source of AC or DC power), in communication with and powering the electric-powered driver. Alternatively or additionally, a generator can be powered using reciprocating engines (e.g., diesel engines) without departing from the scope of the present disclosure. A single pump can be actuated using a single electric-powered driver or multiple electric-powered drivers, and multiple pumps can be actuated using a single electric-powered driver or multiple electric-powered drivers. Similarly, a single power source can power one or multiple electric-powered drivers, or one or multiple electric-powered drivers can be powered by multiple power sources. In an embodiment, the power subsystem can be adapted for simultaneous or selective/alternative use of an on-site power source, such as a generator powered by a natural gas turbine, or a grid power source (e.g., power lines or similar conduits associated with a remote power source).

One or more transformers can be used to alter voltage from the power source to a voltage suitable for powering the electric-powered drivers. One or more variable frequency drives (“VFD(s)”) can be provided in communication with the transformer(s) and respective electric-powered drivers.

### BRIEF DESCRIPTION OF THE DRAWINGS

The novel features believed characteristic of the disclosed subject matter will be set forth in the claims portion of this document. The disclosed subject matter itself, however, as well as a further objectives and advantages thereof, will best be understood by reference to the following detailed description of illustrative embodiments when read in conjunction with the accompanying FIGURES, wherein:

FIG. 1 displays a method 100 for stimulating an oil and/or gas reservoir using only human ingestible materials in accordance with embodiments.

FIG. 2 displays an alternative method 200 for stimulating an oil and/or gas reservoir with human ingestible products in accordance with embodiments.

FIG. 3 displays a schematic view of a hydrocarbon well system 300 in communication with a fracturing formation to produce hydrocarbons when stimulated by fracturing in accordance with embodiments.

FIG. 4 displays the process of endocytosis performed in a human body in accordance with embodiments.

One or more embodiments are described below with reference to the listed Figures.

### DETAILED DESCRIPTION OF ILLUSTRATIVE EMBODIMENTS

Reference now should be made to the FIGURES, in which the same reference numbers are used throughout the different FIGURES to designate the same components.

Before describing selected embodiments of the present subject matter in detail, it is to be understood that the present subject matter is not limited to the particular embodiments described herein. The disclosure and description herein is illustrative and explanatory of one or more presently preferred embodiments of the invention and variations thereof, and it will be appreciated by those skilled in the art that various changes in the design, organization, order of operation, means of operation, equipment structures and location, methodology, and use of mechanical equivalents may be made without departing from the spirit of the embodiments.

As well, it should be understood the drawings are intended illustrate and plainly disclose presently preferred embodiments of the invention to one of skill in the art, but are not intended to be manufacturing level drawings or renditions of final products and may include simplified conceptual views as desired for easier and quicker understanding or explanation of the subject matter. As well, the relative size and arrangement of the components may differ from that shown and still operate within the spirit of the invention as described throughout the present application.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

The disclosure provides methods and systems including the use of human ingestible materials as forming a slurry used to fracture a hydrocarbon formation in a hydraulic fracturing stimulation process. Previous practices incorporate numerous chemicals and toxic products into the fracturing process which, although can be done safely, still pose a hazard to workers, communities, and the environment.

The art of fracturing since its inception has consisted of adding chemicals to the base fluid to viscosify the fluid along with adding a solid material to provide a bridging or propping method to keep the fracture open post treatment. Even as the science of fracturing has progressed, the use of chemicals and proppants not fit for human consumption still remains common and numerous.

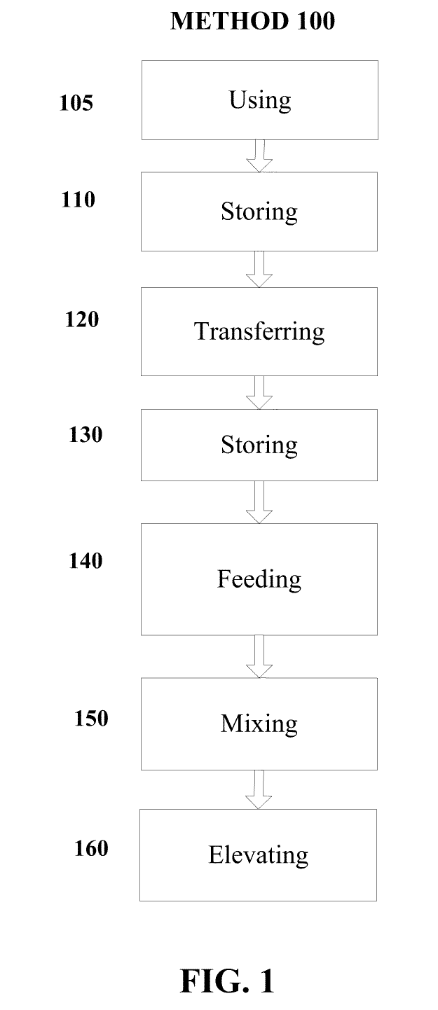

FIG. 1 displays a method 100 for stimulating an oil and/or gas reservoir using only human ingestible materials in accordance with embodiments. Method 100 may include using 105 a binary system including a fracturing fluid comprising heptafluoropropane (“HFP”) and proppant comprising mesoporous silica particles. HFP is a fluid used in the drug industry that is approved and safe for human ingestion, and that is routinely inhaled as the propellant used in asthma inhalers. Mesoporous silica particles are an approved ingestible drug delivery product. In embodiments, HFP may be utilized as a fracturing fluid and mesoporous silica particles may be utilized as a proppant, thus providing a non-toxic stimulation composition that is safe for human ingestion and that may be utilized in method 100 for stimulating an oil and/or gas reservoir.

Method 100 may include storing 110 fracturing fluid comprising HPF under pressure at the well location to maintain the HFP in a liquid state.

Method 100 may include transferring 120 HPF under pressure via boost pump to high pressure fracturing pumps. In an embodiment, fracturing fluid may consist of HFP without added chemical agents.

Method 100 may include storing 130 mesoporous silica proppant in a suitable container at the well location.

Method 100 may include feeding 140 mesoporous silica proppant from a storage vessel. In an embodiment, the proppant may be transferred into an auger which aids in transferring it into the fluid stream. In an embodiment, the feeding 140 may include gravity feeding.

Method 100 may include mixing 150 HFP fracturing fluid and mesoporous silica proppant to form a slurry. In an embodiment, the mixing 150 may be upstream of high pressure fracturing pumps.

Method 100 may include elevating 160 the pressure of the slurry, such as via operation of high pressure pumps, to a pressure sufficiently high to fracture the formation.

In an embodiment, a fracturing method 100 may satisfy requirements for preservation of the environment and human safety. Eliminating the use of water and chemicals may alleviate concerns associated with other processes for stimulating low permeability hydrocarbon reservoirs. Utilizing an approved human ingestible proppant material may eliminate or substantially reduce hazards associated with other proppant materials. For example, some proppant materials have been identified to cause silicosis when inhaled and thus require extensive use of personal breathing safety apparatuses. In an embodiment, the density of the proppant may be matched to the fracturing fluid to enable improved proppant transport by providing desired proppant buoyancy. In an embodiment, providing desired proppant buoyancy may substantially eliminate or abolish settling problems and enable or create long effective propped fractured lengths.

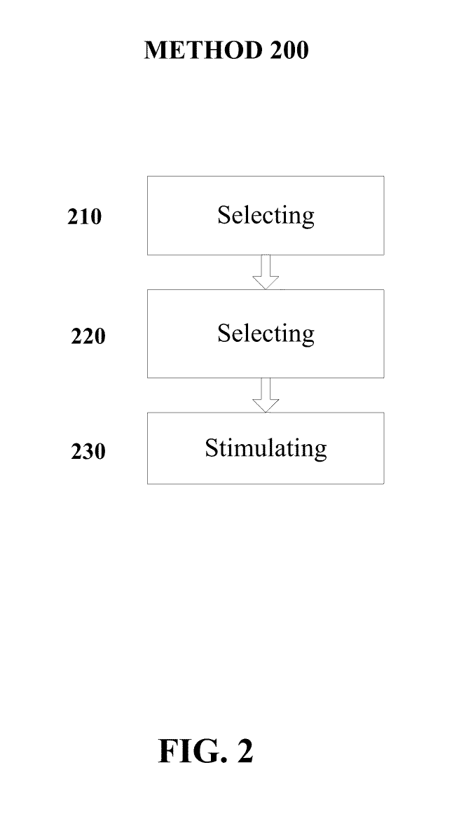

FIG. 2 displays an alternative method 200 for stimulating an oil and/or gas reservoir with human ingestible products in accordance with embodiments. Method 200 may include selecting 210 an appropriate human ingestible proppant having sufficient material strength for forming a slurry with fracturing fluid material used for fracturing. Method 200 may further include selecting 220 an appropriate human ingestible fracturing fluid material for forming a slurry with human ingestible proppant for fracturing. In embodiments, HFP may be utilized as a fracturing fluid. In embodiments, mesoporous silica particles may be utilized as a proppant material. Method 200 may further comprise stimulating 230 a hydrocarbon well formation by pressurizing a slurry to fracture the formation as herein disclosed.

Embodiments may include using a non-toxic binary system utilizing both a fracturing fluid and proppant which are approved for human ingestion and use in the drug delivery field. Reducing the health, safety, and environmental risk can enable the safe and effective practice of fracturing in areas where previous techniques may pose unacceptable risks to community health or the environment or violating regulations. An advantage of embodiments may be delivering better well performance/economics while substantially eliminating health risks associated with previous practices.

The present disclosure provides a human ingestible proppant that may substantially eliminate or reduce the hazards associated with conventional sand or silica based proppants. In an embodiment, a human ingestible proppant may, when ingested, break down by endocytosis and/or enzymatic processes which may render the proppant harmless to a living being. In embodiments, such a human ingestible proppant may comprise a specific gravity of less than 1.50, which, in an embodiment, may be attributed to a mesoporous internal structure of the proppant. In embodiments, the proppants may vary in shape and size. In embodiments, use of a proppant material may substantially eliminate hazards associated with conventional sand or silica based proppants. As used herein, a human ingestible proppant material may include a material of such nature which when ingested into the human body will be broken down by endocytosis and/or enzymatic processes without harm to the person. In an embodiment, a human ingestible proppant may be inert to the conditions encountered when used as a propping material to stimulate a subterranean oil and/or gas reservoir. In an embodiment, a human ingestible proppant may have a density or specific gravity less than 1.50. In an embodiment, such a proppant may have a mesoporous internal structure of the proppant. It will be understandable that a proppant, as herein disclosed, may have varius shapes and sizes.

Previous proppants used to stimulate subterranean oil and/or gas reservoirs include native mined crystalline sand grains and/or man-made ceramic products. Due to numerous factors in the transportation of the sand from the mine to the fracturing site, a meaningful percentage of the crystalline sand grains become damaged creating a hazardous crystalline dust. This crystalline dust is a known health hazard causing silicosis and is described as such by the US Occupational Safety and Health Administration in a fact sheet, as follows: “Crystalline silica dust can cause silicosis, which in severe cases can be disabling, or even fatal. The respirable silica dust enters the lungs and causes the formation of scar tissue, thus reducing the lungs' ability to take in oxygen. There is no cure for silicosis. Since silicosis affects lung function, it makes one more susceptible to lung infections like tuberculosis.”

Typical man-made ceramic proppants include materials such that their densities become even greater than that of conventional sand (2.65 g/cc). In low viscosity fracturing fluids this may be a detriment, at least in part because greater the difference in density between the fluid and the proppant results in proppant settling becoming more pronounced as defined by Stokes Law:

Vertical Settling Rate=(g(Density of Proppant−Density of the Frac Fluid) [(Proppant Dia)] ̂2)/(18(Fluid Viscosity))

This disclosure provides a human ingestible proppant material sufficient for transport of the proppant along a fracture to prop it open. Such a proppant material may have physical properties that may eliminate unacceptable environmental and health dangers. Embodiments may provide improved well performance/economics while also substantially eliminating health risks and environmental risks associated with previous practices.

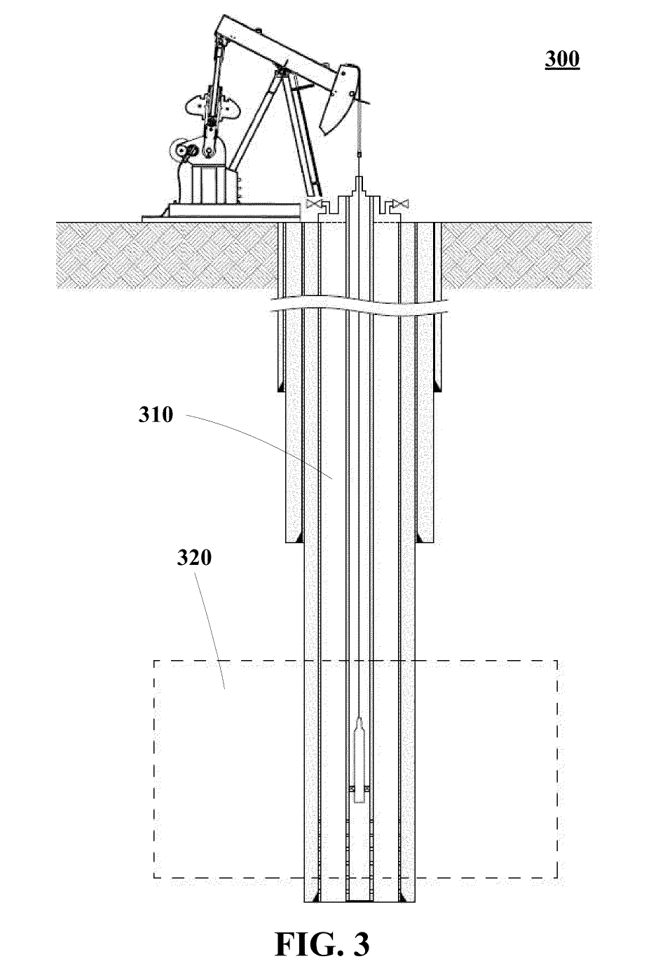

FIG. 3 displays a schematic view of a hydrocarbon well system 300 in communication with a fracturing formation to produce hydrocarbons when stimulated by fracturing in accordance with embodiments.

The hydrocarbon well system 300 may comprise a wellbore 110 and formation fractures in a formation region 320 produced by stimulating the formation region with a human ingestible slurry comprising a fluid and a proppant. In embodiments, the fluid may be HFP. In embodiments, the proppant may be mesoporous silica.

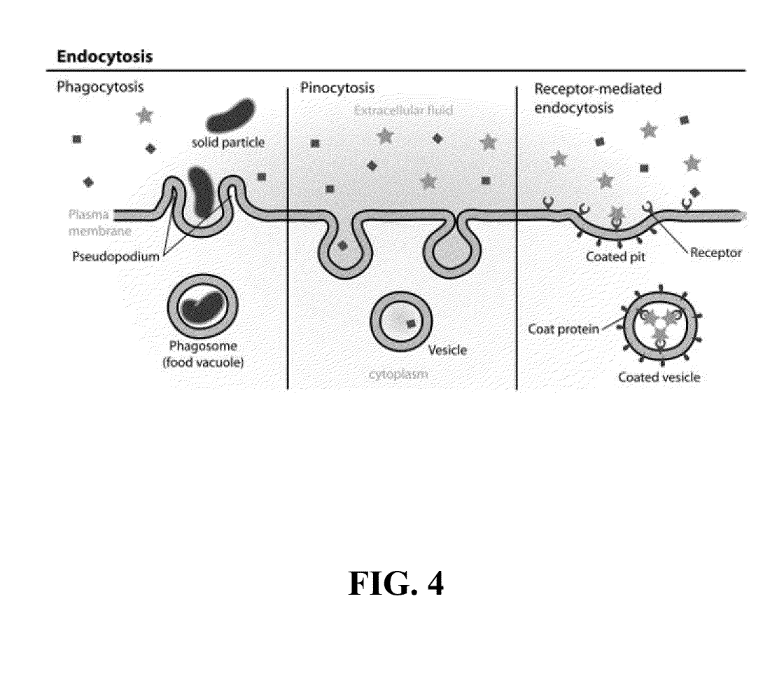

FIG. 4 displays the process of endocytosis performed in a human body in accordance with embodiments. Endocytosis may refer to the internalization of substances from the extracellular environment through the formation of vesicles formed from the plasma membrane of a cell. There may be two forms: (a) fluid phase (pinocytosis) and (b) receptor mediated.

Similar cellular mechanics are involved in “phagocytosis” (fag″o-si-to ´ sis) which is the engulfing of microorganisms or other cells or larger foreign particles by phagocytes, sometimes call “scavenger cells” or “carrier cells” which are prevalent throughout the body.

Phagocytes ingest and kill microbes, present foreign body antigens to lymphocytes, scavenge degenerating material, and release mediators. Classes of phagocytes may include: 1) microphages, which are polymorphonuclear leukocytes that ingest chiefly bacteria; 2) macrophages, which are mononucleated cells (histiocytes and monocytes) that are largely scavengers, ingesting dead tissue and degenerated cells and particulate matter. In embodiments, the slurry and/or particles comprised in the slurry may be ingested and/or destroyed by phagocytes.

In an embodiment, a suitable fracturing fluid may include, or may consist of, a mixture of naturally occurring components of conventional and unconventional hydrocarbons. In an embodiment, a suitable fracturing fluid may include, or may consist of, a selected mixture of low molecular weight alkanes or light alkanes referred to as ‘baby oil” in common language as the stimulation or hydraulic fluid. In an embodiment, a suitable fracturing fluid may include a mixture of light alkanes suitable for use in LAS (Light Alkanes Stimulation), a subset of odorless, colorless technical grade organic oils described in the classifications and/or standards of U.S. Department of Agriculture, U.S. Occupational Safety and Health Administration, U.S. Food and Drug Administration, U.S. Pharmacopeial Convention, NF, BP, DAB, EuP, Japanese and other pharmacopoeias.

In an embodiment, a suitable mixture of light alkanes usable in LAS excludes very low molecular weight alkanes such as natural gas, LPGs, and heavier alkanes. Such excluded heavier alkanes may be solids and may possess different chemical characteristics.

In an embodiment, a suitable fracturing fluid, as herein disclosed, may omit water and any chemical additives. In an embodiment, a fracturing fluid, as herein disclosed, may include a mixture of light alkanes that is supplied from stimulated reservoirs and recovered for reuse. In an embodiment, a suitable fracturing fluid, as herein disclosed, may be a nonflammable mixture of light alkanes having a low vapor pressure and a high flash point. In an embodiment, a suitable fracturing fluid, as herein disclosed, may be non-toxic and approved for use in food preparation, such as personal care products and cosmetics approved by appropriate regulatory agencies such as the FDA. In an embodiment, a suitable fracturing fluid, as herein disclosed, may not deplete atmospheric ozone or may not contribute to global warming. In an embodiment, a suitable fracturing fluid, as herein disclosed, may be used in light alkane stimulation (LAS) systems and methods.

While various embodiments usable within the scope of the present disclosure have been described with emphasis, it should be understood that within the scope of the appended claims, the present invention can be practiced other than as specifically described herein.

1. A method for stimulating an oil and/or gas reservoir with human ingestible products comprising:
storing HPF under pressure on a location of the reservoir to maintain it in a liquid state;
transferring HPF under pressure to high pressure fracturing pumps;
storing mesoporous silica proppant in a container;
feeding the mesoporous silica proppant from the storage vessel into an auger;
mixing the HFP and the mesoporous silica proppant to create a slurry upstream of the high pressure fracturing pumps;
elevating pressure sufficiently high to fracture a formation.

2. The method of claim 1, the transferring of HPF under pressure comprising a boost pump.

3. The method of claim 1, the elevating pressure carried out via high pressure pumps.

4. The method of claim 1, the feeding comprising gravity feeding.

5. A system for the production of petroleum comprising:
a wellbore;
formation fractures produced by stimulating a formation region with a human ingestible slurry comprising a fluid and a proppant.

6. The system of claim 4, the fluid being HFP.

7. The system of claim 4, the proppant being mesoporous silica.
